(19) United States
(12) Patent Application Publication
(10) Pub. No.: US 2010/0280916 A1
(43) Pub. Date: Nov. 4, 2010

(54) SYSTEM AND METHOD FOR MANAGING REQUESTS FOR PROPOSALS

(76) Inventors: B. Kelly Foy, Santa Barbara, CA (US); Murray Adams, Santa Barbara, CA (US); Bradley O. Pirman, Santa Barbara, CA (US); Richard Bryce Johnson, Ventura, CA (US)

Correspondence Address: SHEPPARD, MULLIN, RICHTER & HAMPTON LLP, 12275 EL CAMINO REAL, SUITE 200, SAN DIEGO, CA, 92130, US

(21) Appl. No.: 12/773,529

(22) Filed: May 4, 2010

Related U.S. Application Data
(60) Provisional application No. 61/175,395, filed on May 4, 2009.

(51) Int. Cl. G06Q 30/00

(52) U.S. Cl. 705/26

(57) ABSTRACT

The present invention provides a request for proposal management system hosted on a computing device comprising a buyer proposal management system configured to allow a user to generate requests for proposals to allow the user to generate requests for proposals using information from a provided database of seller information and configured to allow the user to transmit the generated requests for proposals to a selected number of prospective sellers; and a seller proposal management system configured to allow a seller to receive at least one of the transmitted requests for proposals and to respond to the at least one received request for proposal.

### RELATED APPLICATIONS

This application claims the benefit of U.S. Provisional Patent Application Ser. No. 61/175,395, filed May 4, 2009, which is hereby incorporated by reference in its entirety.

### TECHNICAL FIELD

The present invention relates generally to provisioning goods and services, and more particularly, some embodiments relate to submission of and response to requests for proposals (RFPs).

### DESCRIPTION OF THE RELATED ART

A request for proposal (RFP) is a document inviting suppliers of goods or services to propose terms for providing a specific good or service. For example, an RFP in the hospitality industry might comprise an invitation to hotels to accommodate a predetermined number of guests for a predetermined length of time and to provide facilities for the guests to have a scheduled conference. Often the suppliers of goods or services provide forms for buyers used to submit an RFP. Accordingly, buyers are presented with a wide and disparate range of RFP submission forms and response processes. Typically, these buyers manually fill out the RFP forms and submit them to the suppliers individually. Sellers who receive large numbers of RFPs often manually input the data from the received RFPs into corporate sales management databases to generate electronic responses.

### BRIEF SUMMARY OF EMBODIMENTS OF THE INVENTION

According to various embodiments of the invention, a request for proposal management system comprises a buyer request for proposal management portion configured to allow a buyer to generate request for proposals and to submit them to system-using sellers. A seller request for proposal management system allows a seller to receive and maintain such request for proposals and to respond accordingly.

According to an embodiment of the invention, a method for creating a request for proposal comprises selecting a plurality of data fields configured to contain information regarding a proposed service; providing a request for proposal template to a user, the template comprising the selected plurality of fields; populating a first group of the data fields with predetermined information and populating a second group of the data fields with information received from the user to generate a request for proposal; and transmitting the generated request for proposal to a request for proposal management system.

According to another embodiment of the invention, a request for proposal management system hosted on a computing device comprises a buyer proposal management system configured to allow the user to generate requests for proposals using information from a provided database of seller information and configured to allow the user to transmit the generated requests for proposals to a selected number of prospective sellers; and a seller proposal management system configured to allow a seller to receive at least one of the transmitted requests for proposals and to respond to the at least one received request for proposal.

According to a further embodiment of the invention, a method for obtaining prospective recipients of a request for proposal comprises providing a link on a website configured to cause a computer hosting the website to transmit predetermined information to a request for proposal management system hosted on a computing device; the request for proposal management system comprising: a buyer proposal management system configured to allow a user to generate requests for proposals using the transmitted predetermined information and configured to allow the user to transmit the generated requests for proposals to a selected number of prospective sellers; and a seller proposal management system configured to allow a seller to receive at least one of the transmitted requests for proposals and to respond to the at least one received request for proposal.

According to another embodiment of the invention, computer executable program code embodied on a computer readable medium is configured to cause a proposal management system to perform the functions of selecting a plurality of data fields configured to contain information regarding a proposed service; providing a request for proposal template to a user, the template comprising the selected plurality of fields; populating a first group of the data fields with predetermined information and populating a second group of the data fields with information received from the user to generate a request for proposal; transmitting the generated request for proposal to a request for proposal management system.

According to a further embodiment of the invention, computer executable program code embodied on a computer readable medium is configured to cause a host computer to provide a proposal management system comprising a buyer proposal management system configured to allow a user to generate requests for proposals using information from a provided database of seller information and configured to allow the user to transmit the generated requests for proposals to a selected number of prospective sellers; and a seller proposal management system configured to allow a seller to receive at least one of the transmitted requests for proposals and to respond to the at least one received request for proposal.

Other features and aspects of the invention will become apparent from the following detailed description, taken in conjunction with the accompanying drawings, which illustrate, by way of example, the features in accordance with embodiments of the invention. The summary is not intended to limit the scope of the invention, which is defined solely by the claims attached hereto.

### BRIEF DESCRIPTION OF THE DRAWINGS

The present invention, in accordance with one or more various embodiments, is described in detail with reference to the following figures. The drawings are provided for purposes of illustration only and merely depict typical or example embodiments of the invention. These drawings are provided to facilitate the reader's understanding of the invention and shall not be considered limiting of the breadth, scope, or applicability of the invention. It should be noted that for clarity and ease of illustration these drawings are not necessarily made to scale.

FIG. 1 illustrates a buyer request for proposal management system according to an embodiment of the invention.

FIG. 2 illustrates a method for retrieving and providing RFP related data according to an embodiment of the invention.

FIG. 3 illustrates a more detailed RFP buyer management system according to an embodiment of the invention deployed in the hospitality industry.

FIG. 4 illustrates a method of generating an RFP form according to an embodiment of the invention.

FIG. 5 illustrates a seller RFP management system according to an embodiment of the invention deployed in the hospitality industry.

FIG. 6 illustrates an example computing module on which various features of embodiments of the invention may be implemented.

The figures are not intended to be exhaustive or to limit the invention to the precise form disclosed. It should be understood that the invention can be practiced with modification and alteration, and that the invention be limited only by the claims and the equivalents thereof.

### DETAILED DESCRIPTION OF THE EMBODIMENTS OF THE INVENTION

Before describing the invention in detail, it is useful to describe an example environment with which the invention can be implemented. One such example is that of the hospitality industry. Buyers, such as event organizers or company employees planning conferences, may submit requests for proposals (RFPs) to suppliers resellers such as hoteliers or other property owners.

From time-to-time, the present invention is described herein in teams of this example environment. Description in terms of this environment is provided to allow the various features and embodiments of the invention to be portrayed in the context of an exemplary application. After reading this description, it will become apparent to one of ordinary skill in the art how the invention can be implemented in different and alternative environments.

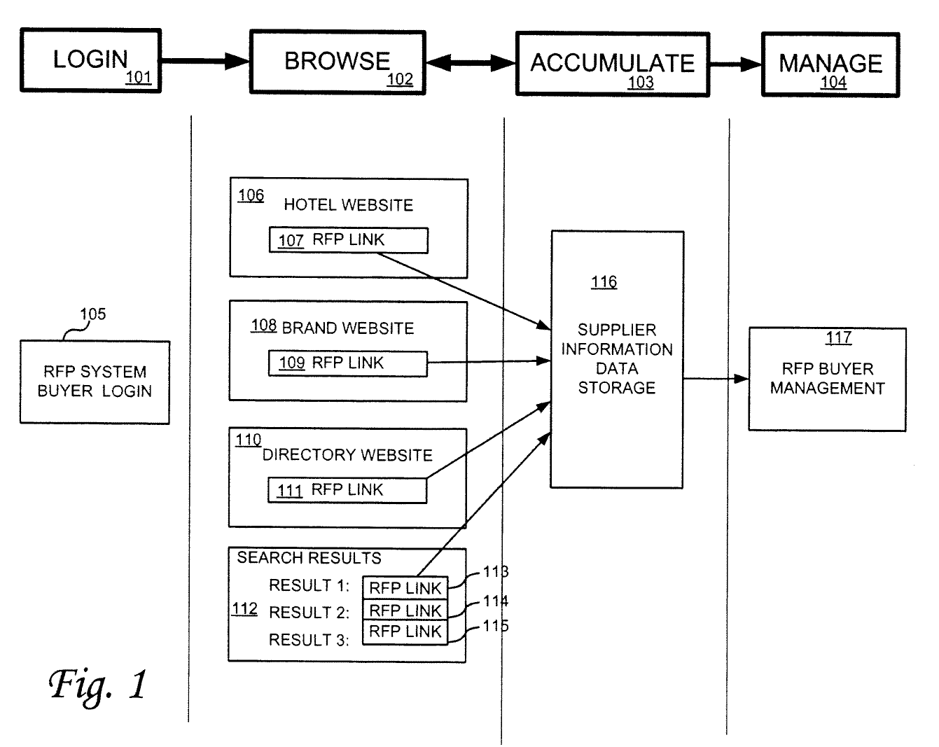

Some embodiments of the invention provide a centralized database and system that allows multiple users to maintain RFP management accounts with the system. These management accounts may comprise both buyer management accounts and supplier management accounts. A user logging into the system using a buyer management account is able to initiate a session to allow the user to accumulate a list of potential suppliers for an RFP. FIG. 1 illustrates one such embodiment of the invention deployed across a group of entities associated with the hospitality industry.

A buyer initiates a session by logging in 101 using an RFP buyer login system 105. Login system 105 may comprise a username and password type login system on a website providing centralized access to the RFP system. Additionally, login systems 105 may be located on various other websites to allow a user to log in to their account without visiting the centralized website. For example, a login system 105 may be located on a specific supplier's website such that a user visiting the supplier website can populate their RFP management account with the supplier's information without leaving the buyer's website.

In this embodiment, the RFP management system is configured to maintain a session while the user investigates various potential suppliers by browsing websites 102 and accumulating 103 a list of potential suppliers. A hotel website 106 includes an RFP link 107 to allow the user to interact with their RFP account without leaving the hotel website 106. For example, the RFP link 107 may be configured to determine the user's session validity, and to update the user's list 116 of potential suppliers if the user has a valid session. Alternatively, hotel website 106 may maintain the RFP link 107 as a template that allows the user to generate and submit an RFP specific to that hotel while simultaneously updating the user's account with the new RFP. In some embodiments, the user may send an existing RFP to a property in a separate, later session.

In some cases, a supplier may own a plurality of hotels and maintain a brand website 108 to display information on that plurality. Such a brand website 108 may provide an RFP link 109 such that when a valid user activates the link, the user's list of potential suppliers 116 is updated with all of or a subset of the brand hotels. For example, the brand website 108 may display a list of all the hotels the brand owns and may further allow the user to select from the list and use the RFP link to update the supplier information 116 with the selected hotels.

Directory websites 110 may be provided to display lists of various hotels. For example, a rating association may rate and display a directory of unaffiliated hotels on a directory website 110. One or more RFP links 111 may be located on the directory website 110.

In further embodiments, methods and systems may be provided to manipulate information displayed on a web browser to allow a user to update their supplier information. For example, a plug-in may be utilized in conjunction with a web browser such that when the user visits a search page 112 and searches for hotels, the plug-in inspects the results of the search. The plug-in may then be displayed on the user's web browser RFP links 113, 114, and 115 corresponding to the search results. Alternatively, the RFP management system may provide a website configured to display external webpages in a frame of the website, such that when the user visits and searches from a search page 112, the results are populated with RFP links 113, 114, and 115.

The RFP management system allows the user to manage 117 RFPs using the accumulated supplier information 116. For example, the RFP management system may provide the user with an RFP form that the user can populate with various information regarding a particular event. The management system 117 is configured to allow the user to transmit the generated RFP to some or all of the suppliers from the accumulated list 116.

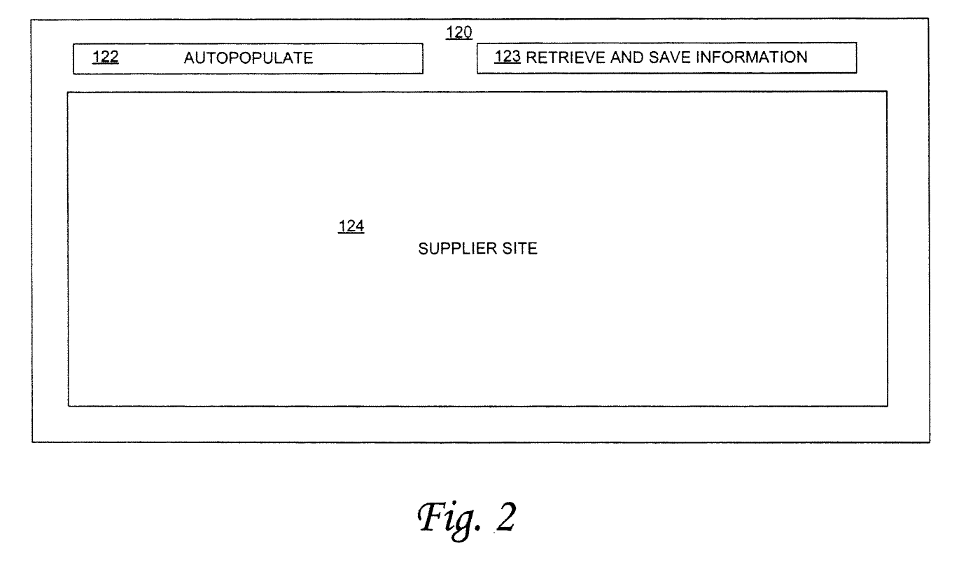

FIG. 2 illustrates a method for retrieving and providing RFP related data according to an embodiment of the invention. In the illustrated embodiment, a buyer is able to log in to a buyer management RFP system 120 that comprises a framed webpage with a frame 124 that allows the user to visit external supplier sites while maintaining a connection to the buyer management RFP system 120. In this embodiment, the supplier site may comprise a fillable web form to allow a prospective buyer to submit an RFP to the supplier or copy from an existing RFP that they've previously created or submitted on another website. Accordingly, the buyer management RFP system 120 may comprise a module 122 configured to auto populate such a fillable web form with predetermined buyer related information. In further embodiments, the buyer management RFP system 120 comprises methods to retrieve and save information from the supplier site 124. For example, the buyer management RFP system 120 may be configured to retrieve sufficient information from supplier site 124 to populate a list of suppliers to receive an RFP, as described herein.

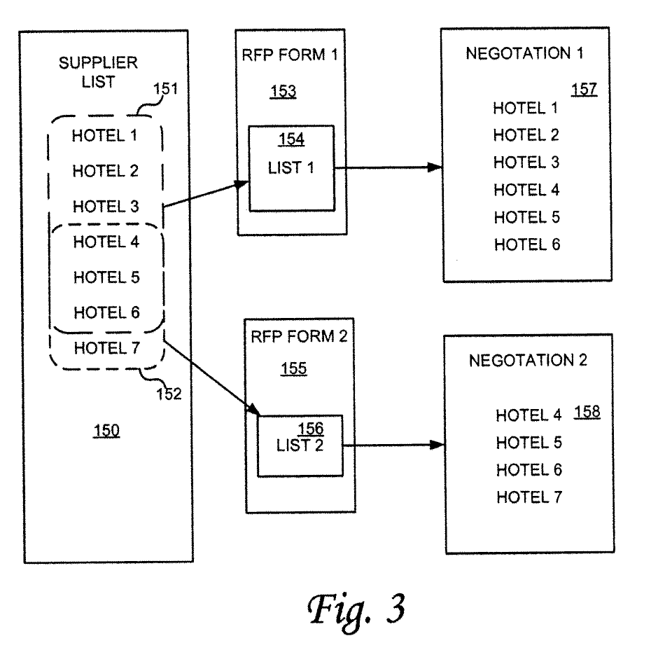

FIG. 3 illustrates a more detailed RFP buyer management system according to an embodiment of the invention deployed in the hospitality industry. The buyer is presented with a list of suppliers 150 and is able to select subsets of hotels 151 and 152 from the list. The RFP buyer management system allows the user to generate RFPs 153 and 155, e.g., representing different events, for transmission to the hotels in the lists 154 and 156. The RFP buyer management system may auto populate the lists 154 and 156 with the results of the selections 151 and 152, and may additionally allow the user to modify the lists by removing or adding other hotels. For example, the RFP management system may maintain a master list of all RFP management enabled hotels to allow the user to supplement the receiving list 154 with further hotels.

The illustrated RFP buyer management system is configured to allow the user to negotiate 157 and 158 with the hotels receiving the transmitted RFPs 153 and 155, respectively. For example, the RFP buyer management system may comprise a messaging system to allow suppliers to respond to the transmitted RFPs and to allow the user to initiate negotiations according to such responses. In further embodiments, the buyer management system may further allow the user and the supplier to finalize their negotiations using the system. For example, the system may further comprise a standardized contract template to allow the user and the hotels selected by the user to form a contract to fulfill the proposal using the system.

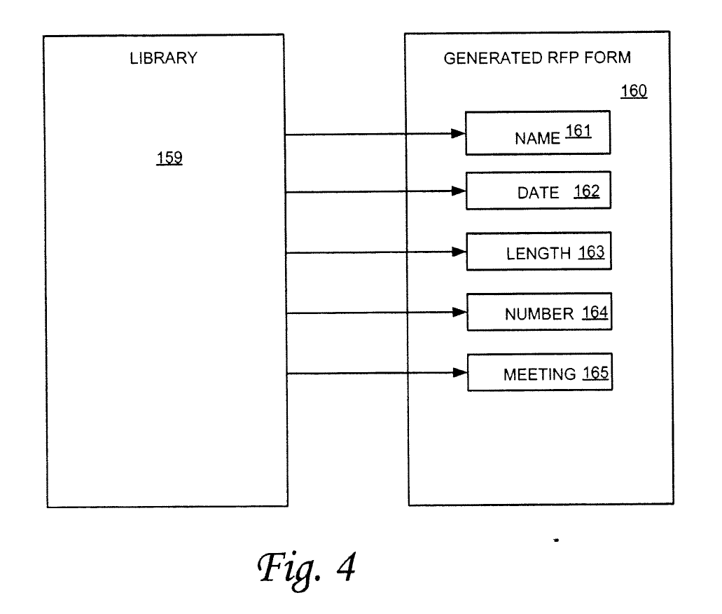

FIG. 4 illustrates a method of generating an RFP form according to an embodiment of the invention. Library 159 comprises a plurality of data field exemplars that may be used to generate RFP forms, such as RFP form 160. The fields contained in library 159 may be configured according to a standardized format, such as APEX compliant RFP form fields. Accordingly, an electronic RFP form 160 may be generated using a selected subset of the fields contained in library 159 such that the information in completed forms is easily extractable by computer management platforms. For example, a generated RFP form 160 may comprise the name field 161 for a title of the proposed meeting, a date field 162, a length of stay field 163, a number of guest field 164, and a meeting room requirement field 165. In some embodiments, certain fields may be required, while other fields are optionally included. For example, a certain number of fields may be required for standards compliance, while other fields may be provided to allow additional information to be provided to sellers.

Such a generated form 160 may be used as a template and provided to buyers from a seller-side website. Such an RFP form 160 may be provided on a seller's website with some or all of the fields pre-populated, for example, with hotel information or buyer information after authentication. An RFP system authenticated user accessing the site may input information in the remaining fields and provide the RFP directly to the seller from the website. In further embodiments, the fields may be auto populated by the RFP system or the seller's website. For example, RFP system performance may be auto populated with user specific information when a logged in user visits a seller's website containing an RFP system enabled form.

In other embodiments, such generated RFP forms 160 may be provided on a non-seller specific website or as a standalone client program. For example, a centralized website may be provided such that a user can generate their own REP form 160 based on their own selections from the library of available fields 159. The user may then save that generated form and use it for current and future proposal needs. Such a centralized website may also comprise a list of available suppliers may allow the user to selectively transmit certain RFPs to certain suppliers.

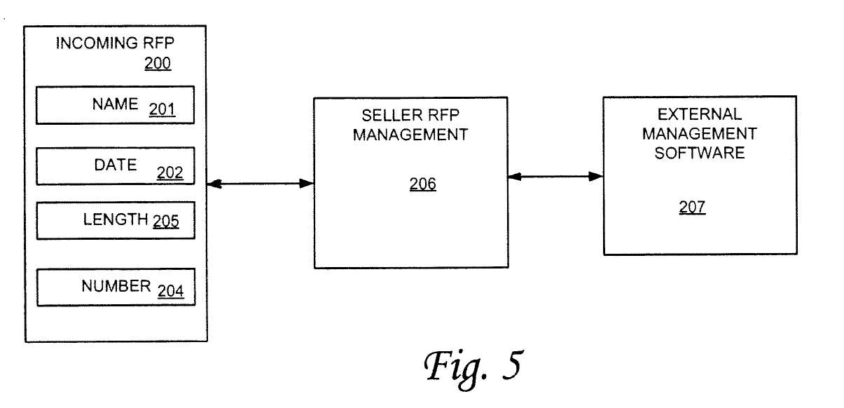

FIG. 5 illustrates a seller RFP management system according to an embodiment of the invention deployed in the hospitality industry. Seller RFP management system 206 is configured to receive incoming RFPs 202 allow the seller to manage their pending RFPs received from various buyers. For example, the seller RFP management system 206 allows the sellers to view and respond to incoming RFPs. In further embodiments, seller RFP management system 206 allows the seller to simultaneously view and compare multiple RFPs such that the seller is able to efficiently allocate available resources as a function of the seller's inventory or resource management. Further embodiments provide additional functionality; for example, the seller may be able to view records of past RFPs received from the buyer sending a particular RFP. Additionally, seller RFP management system 206 allows the seller to respond to received RFPs. For example, the RFP management system in general may provide messaging capabilities, such as an e-mail server, to allow sellers to transmit proposals in response to received RFPs from the seller RFP management system 206 to a buyer RFP management system, as described herein. In some of these embodiments, the seller RFP management system 206 may feature the ability to provide customized RFP responses, such as RFP responses to add the hotel photo and logo to the transmitted responses. In further embodiments, the seller RFP management system 206 allows the seller to respond to RFPs using other means of communication. For example, seller management system 206 may provide an e-mail link allowing the seller to use their personal e-mail address to respond to the RFP, or may provide the phone number for the RFP sender to allow the seller to personally respond to the RFP sender.

The seller RFP management system 206 may provide further functionality to allow the seller to adapt and adjust their responses based on other sellers. For example, the seller RFP management system 206 may optionally provide the seller with information about which other sellers also received the RFP in which seller won the bid. Other functionalities might include providing information about which companies view the seller's website that do not submit RFPs. For example, the RFP system may track logged in buyers as they visit RFP system enabled websites, and provide this information to select sellers.

Seller RFP management system 206 may be further configured to export data received from incoming RFPs to various pre-existing external management software 207. For example, the name 201, date of arrival 202, length of stay 203, and number of guests 204 may be extracted from received RFPs and exported to management software 207 such that pre-existing methods for resource allocations may be utilized. For example, such external management software 207 may comprise a management platform system such as Delphi or MeetingBroker. In these embodiments, the standardization of the form fields and field identifiers allows data from received RFPs to be efficiently extracted without significant errors. Furthermore, the presence of such standardized fields may allow the seller RFP management system 206 to generate autonomous responses to received RFPs that do not meet certain predetermined field data values. For example, a particular seller may determine that any RFP requesting 50 rooms or less elicits an automatically generated response informing the buyer that the specific property is unavailable. In further embodiments, such external management programs may be modified to implement the systems and methods described herein. For example, a toolbar of macros may be provided with a platform 207 to allow a seller to manage the online received RFPs while staying in the platform environment.

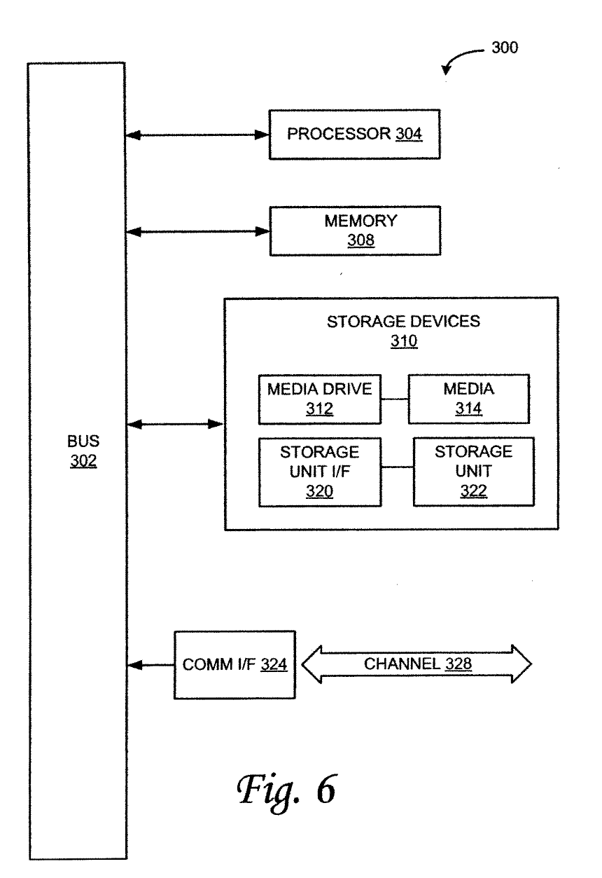

As used herein, the term module might describe a given unit of functionality that can be performed in accordance with one or more embodiments of the present invention. As used herein, a module might be implemented utilizing any form of hardware, software, or a combination thereof. For example, one or more processors, controllers, ASICs, PLAs, PALs, CPLDs, FPGAs, logical components, software routines or other mechanisms might be implemented to make up a module. In implementation, the various modules described herein might be implemented as discrete modules or the functions and features described can be shared in part or in total among one or more modules. In other words, as would be apparent to one of ordinary skill in the art after reading this description, the various features and functionality described herein may be implemented in any given application and can be implemented in one or more separate or shared modules in various combinations and permutations. Even though various features or elements of functionality may be individually described or claimed as separate modules, one of ordinary skill in the art will understand that these features and functionality can be shared among one or more common software and hardware elements, and such description shall not require or imply that separate hardware or software components are used to implement such features or functionality.

Where components or modules of the invention are implemented in whole or in part using software, in one embodiment, these software elements can be implemented to operate with a computing or processing module capable of carrying out the functionality described with respect thereto. One such example computing module is shown in FIG. 6. Various embodiments are described in terms of this example-computing module 300. After reading this description, it will become apparent to a person skilled in the relevant art how to implement the invention using other computing modules or architectures.

Referring now to FIG. 6, computing module 300 may represent, for example, computing or processing capabilities found within desktop, laptop and notebook computers; hand-held computing devices (PDA's, smart phones, cell phones, palmtops, etc.); mainframes, supercomputers, workstations or servers; or any other type of special-purpose or general-purpose computing devices as may be desirable or appropriate for a given application or environment. Computing module 300 might also represent computing capabilities embedded within or otherwise available to a given device. For example, a computing module might be found in other electronic devices such as, for example, digital cameras, navigation systems, cellular telephones, portable computing devices, modems, routers, WAPs, terminals and other electronic devices that might include some form of processing capability.

Computing module 300 might include, for example, one or more processors, controllers, control modules, or other processing devices, such as a processor 304. Processor 304 might be implemented using a general-purpose or special-purpose processing engine such as, for example, a microprocessor, controller, or other control logic. In the illustrated example, processor 304 is connected to a bus 302, although any communication medium can be used to facilitate interaction with other components of computing module 300 or to communicate externally.

Computing module 300 might also include one or more memory modules, simply referred to herein as main memory 308. For example, preferably random access memory (RAM) or other dynamic memory, might be used for storing information and instructions to be executed by processor 304. Main memory 308 might also be used for storing temporary variables or other intermediate information during execution of instructions to be executed by processor 304. Computing module 300 might likewise include a read only memory (“ROM”) or other static storage device coupled to bus 302 for storing static information and instructions for processor 304.

The computing module 300 might also include one or more various fauns of information storage mechanism 310, which might include, for example, a media drive 312 and a storage unit interface 320. The media drive 312 might include a drive or other mechanism to support fixed or removable storage media 314. For example, a hard disk drive, a floppy disk drive, a magnetic tape drive, an optical disk drive, a CD or DVD drive (R or RW), or other removable or fixed media drive might be provided. Accordingly, storage media 314 might include, for example, a hard disk, a floppy disk, magnetic tape, cartridge, optical disk, a CD or DVD, or other fixed or removable medium that is read by, written to or accessed by media drive 312. As these examples illustrate, the storage media 314 can include a computer usable storage medium having stored therein computer software or data.

In alternative embodiments, information storage mechanism 310 might include other similar instrumentalities for allowing computer programs or other instructions or data to be loaded into computing module 300. Such instrumentalities might include, for example, a fixed or removable storage unit 322 and an interface 320. Examples of such storage units 322 and interfaces 320 can include a program cartridge and cartridge interface, a removable memory (for example, a flash memory or other removable memory module) and memory slot, a PCMCIA slot and card, and other fixed or removable storage units 322 and interfaces 320 that allow software and data to be transferred from the storage unit 322 to computing module 300.

Computing module 300 might also include a communications interface 324. Communications interface 324 might be used to allow software and data to be transferred between computing module 300 and external devices. Examples of communications interface 324 might include a modem or softmodem, a network interface (such as an Ethernet, network interface card, WiMedia, IEEE 802.XX or other interface), a communications port (such as for example, a USB port, IR port, RS232 port Bluetooth® interface, or other port), or other communications interface. Software and data transferred via communications interface 324 might typically be carried on signals, which can be electronic, electromagnetic (which includes optical) or other signals capable of being exchanged by a given communications interface 324. These signals might be provided to communications interface 324 via a channel 328. This channel 328 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to media such as, for example, memory 308, storage unit 320, media 314, and signals on channel 328. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing module 300 to perform features or functions of the present invention as discussed herein.

While various embodiments of the present invention have been described above, it should be understood that they have been presented by way of example only, and not of limitation. Likewise, the various diagrams may depict an example architectural or other configuration for the invention, which is done to aid in understanding the features and functionality that can be included in the invention. The invention is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the present invention. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the invention is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus, the breadth and scope of the present invention should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

1. A method for creating a request for proposal, comprising:
selecting a plurality of data fields configured to contain information regarding a proposed service;
providing a request for proposal template to a user, the template comprising the selected plurality of fields;
populating a first group of the data fields with predetermined information and populating a second group of the data fields with information entered by the user to generate the request for proposal; and
transmitting the generated request for proposal to a request for proposal management system.

2. The method of claim 1, wherein the proposal management system comprises a supplier proposal management system.

3. The method of claim 2, wherein the supplier proposal management system is configured to export information contained in the populated data fields to a predetermined management platform.

4. The method of claim 1, wherein the proposal management system comprises a buyer proposal management system, and further comprising transmitting the generated request for proposal to a supplier.

5. The method of claim 4, wherein the buyer proposal management system allows the user to modify the generated request for proposal; and further comprising transmitting the modified request for proposal to the supplier.

6. A request for proposal management system hosted on a computing device; comprising:
a buyer proposal management system configured to allow a user to generate requests for proposals to allow the user to generate requests for proposals using information from a provided database of seller information and configured to allow the user to transmit the generated requests for proposals to a selected number of prospective sellers; and
a seller proposal management system configured to allow a seller to receive at least one of the transmitted requests for proposals and to respond to the at least one received request for proposal.

7. The system of claim 6, wherein the buyer proposal management system is further configured to allow the user to select from a predetermined plurality of information fields to generate the requests for proposals.

8. The system of claim 7, wherein the predetermined plurality of information fields comprise information fields formatted according to a predetermined standard.

9. The system of claim 6, wherein the buyer proposal management system is further configured to allow the user to modify a previously generated request for proposal prior to receiving a response to the previous request.

10. The system of claim 6, wherein the seller proposal management system is configured to allow the seller to view data concerning a plurality of received requests for proposals simultaneously.

11. The system of claim 6, wherein the seller proposal management system is further configured to export data contained in a received request for proposal to an external management platform.

12. A method for obtaining prospective recipients of a request for proposal, comprising:
providing a link on a website configured to cause a computer hosting the website to transmit predetermined information to a request for proposal management system hosted on a computing device; the request for proposal management system comprising:
a buyer proposal management system configured to allow a user to generate requests for proposals using the transmitted predetermined information and configured to allow the user to transmit the generated requests for proposals to a selected number of prospective sellers; and
a seller proposal management system configured to allow a seller to receive at least one of the transmitted requests for proposals and to respond to the at least one received request for proposal.

13. The method of claim 6, wherein the transmitted predetermined information comprises information configured to allow the proposal management system to generate a list of prospective recipients of requests for proposals.

14. The method of claim 6, wherein the transmitted predetermined information comprises information configured to allow a field included in a request for proposal to be automatically populated with data.

15. The method of claim 6, wherein the predetermined information is received from the proposal management system.

16. Computer executable program code embodied on a computer readable medium configured to cause a proposal management system to perform the functions of:
selecting a plurality of data fields configured to contain information regarding a proposed service;
providing a request for proposal template to a user, the template comprising the selected plurality of data fields;
populating a first group of the data fields with predetermined information and populating a second group of the data fields with information received from the user to generate a request for proposal;
transmitting the generated request for proposal to a request for proposal management system.

17. Computer executable program code embodied on a computer readable medium configured to cause a host computer to provide a proposal management system comprising:
a buyer proposal management system configured to allow a user to generate requests for proposals using information from a provided database of seller information and configured to allow the user to transmit the generated requests for proposals to a selected number of prospective sellers; and
a seller proposal management system configured to allow a seller to receive at least one of the transmitted requests for proposals and to respond to the at least one received request for proposal.

18. The computer executable program code of claim 17, wherein the buyer proposal management system is further configured to allow the user to modify a previously generated request for proposal prior to receiving a response to the previously generated request.

19. The computer executable program code of claim 17, wherein the seller proposal management system is configured to allow the seller to simultaneously view data concerning a plurality of received requests for proposals.

20. The computer executable program code of claim 17, wherein the seller proposal management system is further configured to export data contained in a received request for proposal to an external management platform.
